(19) United States
(12) Patent Application Publication
(10) Pub. No.: US 2014/0046670 A1
(43) Pub. Date: Feb. 13, 2014

(54) AUDIO ENCODING METHOD AND APPARATUS, AUDIO DECODING METHOD AND APPARATUS, AND MULTIMEDIA DEVICE EMPLOYING THE SAME

(71) Applicant: SAMSUNG ELECTRONICS CO., LTD., Suwon-si (KR)

(72) Inventors: Han-gil MOON, Daejeon (KR); Hyun-wook KIM, Suwon-si (KR); Nam-suk LEE, Suwon-si (KR); Eun-mi OH, Seoul (KR)

(73) Assignee: SAMSUNG ELECTRONICS CO., LTD., Suwon-si (KR)

(21) Appl. No.: 13/909,470

(22) Filed: Jun. 4, 2013

Related U.S. Application Data
(60) Provisional application No. 61/655,269, filed on Jun. 4, 2012.

(51) Int. Cl. G10L 19/02

(52) U.S. Cl. CPC G10L 19/02
USPC 704/500

(57) ABSTRACT

Provided is a method of encoding an audio signal. A method of encoding an audio signal includes generating a modified signal of a time domain to compensate a frequency resolution in frame units, analysis-windowing the modified signal of the time domain by using a window type which is designed to have an overlapping section less than 50%, and generating transform coefficients of a frequency domain by transforming the analysis-windowed signal of the time domain.

### RELATED APPLICATIONS

This application claims the benefit of U.S. Provisional Application No. 61/655,269, filed on Jun. 4, 2012, in the United States Patent and Trademark Office, the disclosure of which is incorporated herein by reference in its entireties.

### BACKGROUND

1. Field

Apparatuses and methods consistent with exemplary embodiments relate to encoding and decoding an audio signal, and more particularly, to a method and apparatus for generating transform coefficients of a frequency domain by transforming and encoding an audio signal of a time domain, and reconstructing an audio signal of a time domain by decoding and inverse-transforming the transform coefficients of the frequency domain, and a multimedia device which employs the same.

2. Description of the Related Art

Recently, demands on a new audio/video (A/V) service such as cloud computing as well as an Internet-based speech communication service such as a voice over Internet protocol (VoIP) or teleconferencing are on a rapid increase. Likewise, a new A/V service, which provides interactivity in an environment between media and a user, for example, a server-client environment, needs reduction of the time delay for the user's absorption.

Here, a low delay and high sound quality are in trade-off relation. Hence, in order to appropriately support a new A/V service, there is a need for achieving a low delay while minimizing deterioration of the restored sound quality according to the environment where the user is facing, achieving a low delay while maintaining a constant restored sound quality, or achieving a low delay while improving the restored sound quality.

### SUMMARY

Aspects of one or more exemplary embodiments provide a method and apparatus for effectively applying a time-frequency transform process/inverse-transform process in an encoding and decoding process of an audio signal, and a multimedia device which employs the same.

Aspects of one or more exemplary embodiments provide a method and apparatus for preventing an unnecessary delay when performing a time-frequency transform/inverse-transform process, and a multimedia device which employs the same.

Aspects of one or more exemplary embodiments provide a method and apparatus for improving a restored sound quality while reducing a process delay by using a reduced overlapping section when performing a time-frequency transform process/inverse-transform process, and a multimedia device which employs the same.

Aspects of one or more exemplary embodiments provide a method and apparatus for effectively applying a time-frequency transform process/inverse-transform process in an encoding and decoding process of an audio signal, and a multimedia device which employs the same.

Aspects of one or more exemplary embodiments provide a method and apparatus for preventing an unnecessary delay when performing a time-frequency transform/inverse-transform process, and a multimedia device which employs the same.

Aspects of one or more exemplary embodiments provide a method and apparatus for improving a restored sound quality while reducing a process delay by using a reduced overlapping section when performing a time-frequency transform process/inverse-transform process, and a multimedia device which employs the same.

According to an aspect of one or more exemplary embodiments, there is provided a method of encoding an audio signal, the method including: generating a modified signal in a time domain to compensate a frequency resolution in frame units; analysis-windowing the modified signal in the time domain by using a window which is designed to have an overlapping section less than 50%; and generating transform coefficients in a frequency domain by transforming the analysis-windowed signal in the time domain.

The method further includes merging frequency bins toward a low-frequency band in sub-band units for transform coefficients in the frequency domain in order to improve the frequency resolution.

The method further includes applying different block sizes in sub-band units according to characteristics of the transform coefficients in the frequency domain in order to improve the frequency resolution.

The generating of the modified signal in the time domain includes removing a periodic component in frame units and representing the removed periodic component as a separate parameter.

The analysis-windowing includes applying at least two window types which are designed to have a same overlapping section except a section where a window coefficient is 0 so that perfect reconstruction is possible in the overlapping section, while having different lengths.

According to an aspect of one or more exemplary embodiments, there is provided a method of decoding an audio signal, the method including: restoring a frequency resolution by demerging frequency bins in sub-band units for a signal in a frequency domain which is decoded from a bitstream; inverse-transforming the resolution-restored signal in the frequency domain into a signal in a time domain; and synthesis-windowing the signal in the time domain by using a window type which is designed to have an overlapping section less than 50%.

The method further includes reconstructing an audio signal before resolution compensation by performing post-filtering on the synthesis-windowed signal in the time domain, corresponding to pre-filtering which is performed in an encoding process.

The synthesis-windowing includes applying at least two window types which are designed to have a same overlapping section except a section where a window coefficient is 0 so that perfect reconstruction is possible in the overlapping section, while having different lengths.

According to an aspect of one or more exemplary embodiments, there is provided an apparatus for decoding an audio signal, the apparatus including: a pre-filtering unit configured to generate a modified signal in a time domain to compensate a frequency resolution in frame units; an analysis-windowing unit configured to perform analysis-windowing on the modified signal in the time domain by using a window type which is designed to have an overlapping section less than 50%; a transform unit configured to transform an analysis-windowed signal in the time domain into a signal in a frequency domain; and a resolution enhancement unit configured to merge frequency bins toward a low-frequency band in sub-band units for the signal in the frequency domain to improve the frequency resolution.

According to an aspect of one or more exemplary embodiments, there is provided an apparatus for decoding an audio signal, the apparatus including: a frequency resolution restoration unit configured to restore a frequency resolution by demerging frequency bins in sub-band units for a signal in a frequency domain which is decoded from a bitstream; an inverse-transform unit configured to inverse-transform the resolution-restored signal in the frequency domain into a signal in a time domain; a synthesis-windowing unit configured to perform synthesis-windowing on the signal in the time domain by using a window type which is designed to have an overlapping section less than 50%; and a post-filtering unit configured to reconstruct an audio signal before resolution compensation by performing post-filtering on the synthesis-windowed signal in the time domain, corresponding to pre-filtering which is performed in an encoding process.

According to an aspect of one or more exemplary embodiments, there is provided a multimedia device including: a communication unit configured to receive at least one of an audio signal and an encoded bitstream, or transmit at least one of an encoded audio signal and a reconstructed audio signal; and a decoding module configured to restore a frequency resolution by demerging frequency bins in sub-band units for a signal in a frequency domain which is decoded from a bitstream, inverse-transform the resolution-restored signal in the frequency domain into a signal in a time domain, and perform synthesis-windowing on the signal in the time domain by using a window type which is designed to have an overlapping section less than 50%.

The multimedia device further includes an encoding module configured to generate a modified signal in a time domain to compensate a frequency resolution in frame units, perform analysis-windowing on the modified signal in the time domain by using a window type which is designed to have an overlapping section less than 50%, and transform the analysis-windowed signal in the time domain into a signal in a frequency domain.

### BRIEF DESCRIPTION OF THE DRAWINGS

These and/or other aspects will become apparent and more readily appreciated from the following description of the exemplary embodiments, taken in conjunction with the accompanying drawings of which:

FIG. 1 is a block diagram illustrating a configuration of an audio encoding apparatus according to an exemplary embodiment;

FIG. 2 is a block diagram illustrating a configuration of an audio decoding apparatus according to an exemplary embodiment;

FIGS. 3A and 3B are diagrams illustrating an example of a filter response of a pre-filter and a post filter which are applied in the exemplary embodiments;

FIG. 4 is a diagram illustrating an example of a window type which is applied in the exemplary embodiments;

FIGS. 5A to 5C are diagrams illustrating a time delay which is generated by encoding and decoding when using the window type illustrated in FIG. 4;

FIGS. 6A to 6C are diagrams illustrating an example of various window types which are applied in the exemplary embodiments;

FIG. 7 is a diagram illustrating an example where an window illustrated in FIG. 6 is applied to each frame;

FIGS. 8A and 8B are diagrams illustrating a concept of an enhancing resolution process which is applied in the exemplary embodiments;

FIG. 9 is a flowchart illustrating an operation of an audio encoding method according to an exemplary embodiment;

FIG. 10 is a flowchart illustrating an operation of an audio decoding apparatus according to an exemplary embodiment;

FIG. 11 is a block diagram illustrating a multimedia device according to an exemplary embodiment;

FIG. 12 is a block diagram illustrating a multimedia device according to an exemplary embodiment; and

FIG. 13 is a block diagram illustrating multimedia device according to an exemplary embodiment.

### DETAILED DESCRIPTION

Reference will now be made in detail to exemplary embodiments, examples of which are illustrated in the accompanying drawings, wherein like reference numerals refer to the like elements throughout. In this regard, the exemplary embodiments may have different forms and should not be construed as being limited to the descriptions set forth herein. Accordingly, the exemplary embodiments are merely described below, by referring to the figures, to explain aspects of the present inventive concept. As used herein, the term “and/or” includes any and all combinations of one or more of the associated listed items. Expressions such as “at least one of,” when preceding a list of elements, modify the entire list of elements and do not modify the individual elements of the list.

Terms such as “connected” and “linked” may be used to indicate a directly connected or linked state, but it shall be understood that another component may be interposed therebetween.

Terms such as “first” and “second” may be used to describe various components, but the components shall not be limited to the terms. The terms may be used only to distinguish one component from another component.

The units described in exemplary embodiments are independently illustrated to indicate different characteristic functions, and it does not mean that each unit is formed of one separate hardware or software component. Each unit is illustrated for the convenience of explanation, and a plurality of units may form one unit, and one unit may be divided into a plurality of units.

Currently, a plurality of codec technologies are being used in encoding/decoding audio signals. Each codec technology has characteristics which are appropriate for a specific audio signal, and is optimized for the audio signal. Some examples of codec, which uses modified discrete cosine transform (MDCT), are advanced audio coding (AAC) series of MPEG, G.722.1, G.929.1, G.718, G.711.1, G.722 super wide band (SWB), G.729.1/G718 SWB, and G.722 SWB, and these codecs are based on a perceptual coding scheme in which the encoding process is performed by means of a combination of a filter bank to which the MDCT is applied and a psychoacoustic model. The MDCT is being widely used in the audio codec due to the advantage that the signals in the time domain may be effectively reconstructed by using the overlap-and-add scheme.

Likewise, various codecs which use the MDCT are being used, but each codec may have a different structure to obtain intended effects. For example, the ACC series of the MPEG performs encoding by means of a combination of the MDCT (filter bank) and the psychoacoustic model, and the AAC-enhanced low delay (ACC-ELD) performs encoding using the MDCT having a low delay. In addition, G.722.1 quantizes the coefficients by applying the MDCT to the entire band, and G.718 wideband (WB) encodes the quantization error into the MDCT-based enhanced layer in the layered WB codec and super wideband (SWB) codec. Moreover, enhanced variable rate codec (EVRC)-WB, G.729.1, G.718, G.711.1, G.718/G.729.1 SWB, etc. encodes the band-divided signal into the MDCT-based enhanced layer in the layered WB codec and SWB codec.

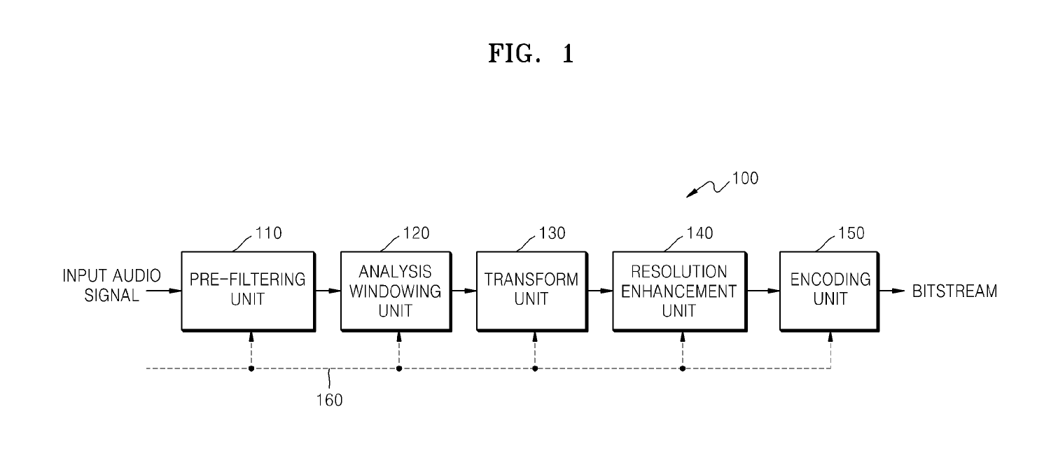

FIG. 1 is a block diagram illustrating an audio encoding apparatus 100 according to an exemplary embodiment.

The audio encoding apparatus 100 of FIG. 1 may include a pre-filtering unit 110, an analysis windowing unit 120, a transform unit 130, a resolution enhancement unit 140, and an encoding unit 150. Various parameters, which are needed for encoding, such as the length of a signal, window types, and bit allocation information, may be transmitted to each unit 110 to 150 of the encoding apparatus 100 through the additional route 160. It is illustrated in the exemplary embodiment that additional information needed for operation of each unit 110 to 150 may be transmitted through the additional route 160, but this is for the convenience of explanation, and thus the additional information may be sequentially transmitted to each unit, i.e., the pre-filtering unit 110, the analysis windowing unit 120, the transform unit 130, the resolution enhancement unit 140, and the encoding unit 150 along with signals according to the operation order of each illustrated unit without a separate additional route 160. In addition, respective components may be integrated as at least one module and may be implemented as at least one processor (not shown). Here, the audio may represent music, speech, or a mixed signal of music and speech.

Referring to FIG. 1, the pre-filtering unit 110 may detect periodic components from an audio signal which is input in frame units, remove the detected periodic components, and generate a modified audio signal by representing the removed periodic components as a separate parameter. Here, the frame may indicate a general frame, a subframe which is a lower frame of the frame, or a lower frame of the subframe. According to an exemplary embodiment, the periodic components may include a harmonic component such as pitch. For example, when the periodic component is a pitch, the pre-filtering unit 110 may detect the pitch using various known pitch detection algorithms, and design the filter coefficients in consideration of the location and amplitude of the detected pitch and apply the filter coefficients to the input audio signal. The pre-filtering process may be applied to all frames, or may be applied to frames where periodic components have been first detected. A separate parameter including filter coefficients related with the location and amplitude of the detected pitch may be included in the bitstream so as to be transmitted. Likewise, the modified audio signal, from which pitch components have been removed, may have a whitened characteristic compared to an audio signal including pitch components, and thus has a feature that is robust against quantization noise during quantization.

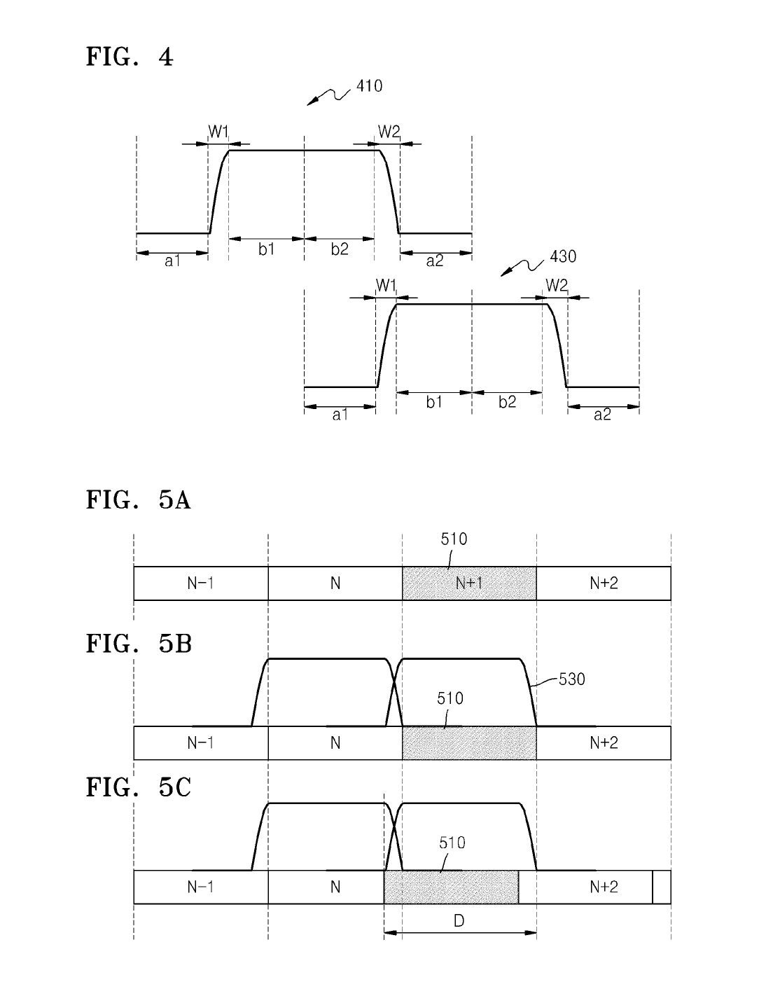

The analysis windowing unit 120 may perform analysis windowing for the modified audio signal which is provided from the pre-filtering unit 110. According to an exemplary embodiment, the applied window type may have an overlapping section less than 50%. In addition, when two window types having the same length overlap or two window types having different lengths overlap, the lengths of the overlapping sections may be set to be the same exempting the section where the window coefficient is 0 in order to satisfy the perform reconstruction condition, which will be described later with reference to FIGS. 4 to 7.

The transform unit 130 may generate the transform coefficients in the frequency domain by transforming the audio signal in the time domain where the windowing process has been performed in the analysis windowing unit 120. DCT, modified discrete cosine transform (MDCT), or fast Fourier transform (FFT) may be used for the transform process, but one or more exemplary embodiments are not limited thereto.

The resolution enhancement unit 140 may adjust the time-frequency resolution in sub-band units for the transform coefficients in the frequency domain which are generated in the transform unit 130. For example, in a frame where a tone component, a stationary component, and a transient component coexist, relatively a long block size may be applied to a tone component or a stationary component, and relatively a short block size may be applied to the transient component. As a result, in the tone component or the stationary component, the frequency resolution may increase, but the time resolution decreases and, in the transient component, the frequency resolution may decrease, but the time resolution may increase, and thus resolution which is adaptive to signal characteristics may be obtained. The information on the applied block size may be included in the bitstream. In addition, the resolution enhancement unit 140 may merge frequency bins toward a low-frequency band or high-frequency band in sub-band units. Walsh matrix of rank 2ⁿ may be used to merge frequency bins which exist in each sub-band. The Walsh matrix may be drawn from Hadamard matrix of rank 2ⁿ. According to an exemplary embodiment, the resolution enhancement unit 140 may enhance the frequency resolution of the low frequency band throughout the entire frames by merging the frequency bins toward a low-frequency band in each sub-band unit. Another known matrix may be used to merge frequency bins which exist in each sub-band. Information on the matrix which is used in merging the frequency bins may be included in the bitstream.

The encoding unit 150 may perform an encoding process including quantization for transform coefficients whose resolution has been adjusted in the resolution enhancement unit 140. The result of encoding in the encoding unit 150 and the encoding parameters which are needed for decoding may form a bitstream, and the bitstream may be stored in a predetermined storage medium or may be transmitted through a channel.

According to an exemplary embodiment, both the pre-filtering unit 110 and the resolution enhancement unit 140 may be used, and at least one of the pre-filtering unit 110 and the resolution enhancement unit 140 may be used according to the use of the device where the encoding apparatus or the decoding apparatus is embedded. To this end, when there is a need of a user's selection, a separate switching unit may be provided. When selectively used, a flag related with whether to perform the pre-filtering process or resolution enhancement process may be added to the header of the bitstream so that the corresponding process may be performed in the decoding apparatus.

Furthermore, according to another exemplary embodiment, the same window type as in the existing AAC codec is applied in the analysis windowing unit 120, and the pre-filtering unit 110 and the resolution enhancement unit 140 are additionally included and are entirely or selectively operated to enhance the restored sound quality.

Furthermore, according to another exemplary embodiment, a single window type, for example, a short window or a long window, may be applied in the analysis windowing unit 120, and the pre-filtering unit 110 and the resolution enhancement unit 140 may be additionally included and may be entirely or selectively operated to enhance the restored sound quality.

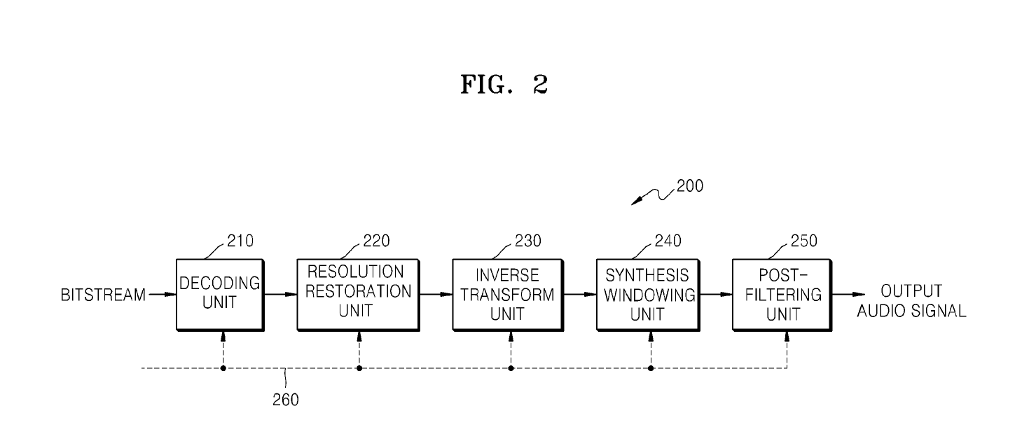

FIG. 2 is a block diagram illustrating an audio decoding apparatus 200 according to an exemplary embodiment.

The audio decoding apparatus 200 illustrated in FIG. 2 may include a decoding unit 210, a resolution restoration unit 220, an inverse-transform unit 230, a synthesis windowing unit 240, and a post filtering unit 250. Various parameters, which are needed for decoding, such as the length of a signal, window types, and bit allocation information, may be transmitted to each unit 210 to 250 of the decoding apparatus 200 through the additional route 260. It is illustrated in the exemplary embodiment that additional information needed for operation of each unit 210 to 250 may be transmitted through the additional route 260, but this is for the convenience of explanation, and thus the additional information may be sequentially transmitted to each unit, i.e., the decoding unit 210, the resolution restoration unit 220, the inverse-transform unit 230, the synthesis windowing unit 240, and the post filtering unit 250 along with signals according to the operation order of each illustrated unit without a separate additional route 260. In addition, respective components may be integrated as at least one module and may be implemented as at least one processor (not shown). Here, the audio may represent music, speech, or a mixed signal of music and speech.

Referring to FIG. 2, the decoding apparatus 210 may receive a bitstream and perform dequantization to obtain transform coefficients in the frequency domain.

The resolution restoration unit 220 may restore the resolution by demerging frequency bins in sub-band units for the transform coefficients in the frequency domain which are provided from the decoding unit 210. To this end, the inverse matrix of the matrix, which has been used in merging the frequency bins in the resolution enhancement unit 140 of the encoding apparatus 100, may be used.

The inverse-transform unit 230 may generate the signal in the time domain by inverse-transforming transform coefficients in the frequency domain whose resolution has been restored by the resolution restoration unit 220. To this end, the inverse-transform process corresponding to the transform process used in the transform unit 130 of the encoding apparatus 100 may be performed. For example, when the MDCT is applied in the transform unit 130 of the encoding apparatus 100, the inverse-transform unit 230 may transform the transform coefficients in the frequency domain into a signal in the time domain by applying the IMDCT to the transform coefficients.

The synthesis windowing unit 240 may perform synthesis windowing for the signal in the time domain which is provided from the inverse-transform unit 230. To this end, the same window type as in the window type, which has been applied in the analysis windowing unit 120 of the encoding apparatus 100, may be applied. The synthesis windowing unit 240 may restore the signal of the time domain by performing the overlap-and-add process for the signal in the time domain to which the synthesis window has been applied.

The post filtering unit 250 may post-filter the signal in the time domain which is provided from the synthesis windowing unit 240 so as to reconstruct the signal to the signal before the pre-filtering in the encoding apparatus 100. As a result, the periodic component, which has been removed from the pre-filtering unit 110 of the encoding apparatus 100, may be reconstructed by the post filter which uses a separate parameter which has been transmitted from the encoding apparatus 100.

According to an exemplary embodiment, both the resolution restoration unit 200 and the post filtering unit 250 may be used, or the resolution restoration unit 200 and the post filtering unit 250 may be selectively used. For example, a flag related with whether to perform a pre-filtering process or whether to perform a resolution enhancement process included in the header of the bitstream may be referred to for the selective use.

According to another exemplary embodiment, the same window type as in the existing AAC codec may be applied in the synthesis windowing unit 240 to correspond to the encoding apparatus 100, and the resolution restoration unit 220 and the post-filtering unit 250 may be additionally included and are entirely or selectively operated to enhance the restored sound quality.

According to another exemplary embodiment, a single window type, for example, a short window or a long window, may be applied in the synthesis windowing unit 240 to correspond to the encoding apparatus 100, and the resolution restoration unit 220 and the post-filtering unit 250 may be additionally included and may be entirely or selectively operated to enhance the restored sound quality.

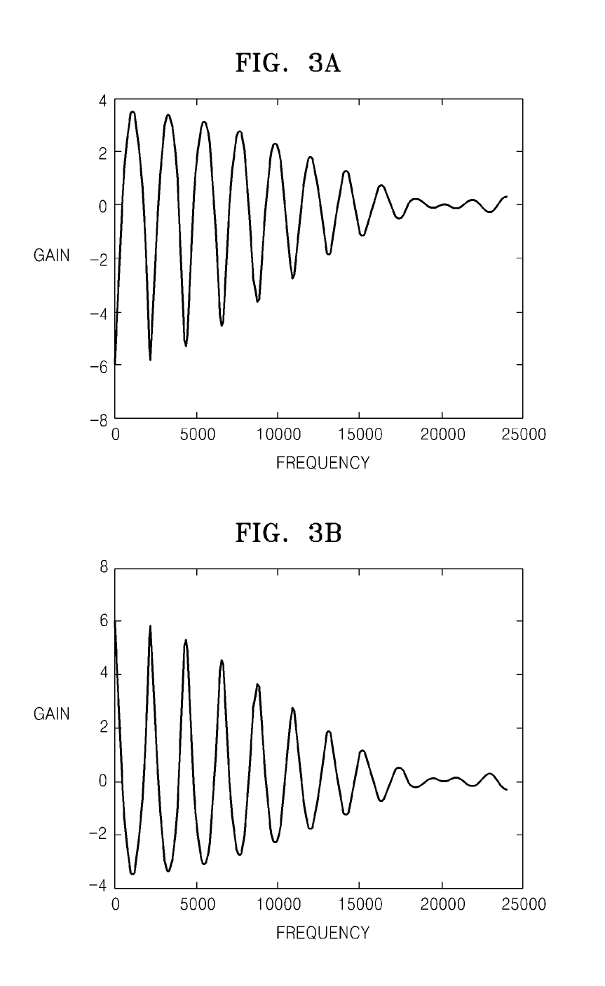

FIGS. 3A and 3B are diagrams illustrating an example of a filter response of a pre-filter and a post filter which are applied in the exemplary embodiments. FIG. 3A shows a filter response of a pre-filter which is implemented in a pole-zero comb filter, and FIG. 3B shows a filter response of a post filter corresponding to the pre-filter of FIG. 3A. FIG. 3A may be used in the encoding apparatus, and FIG. 3B may be used in the decoding apparatus.

A transfer function (Hₚᵣₑ(z)) of the pre-filter of FIG. 3A and a transfer function (Hₚₒₛₜ(z)) of the post filter of FIG. 3B may be shown as in equation 1 below.

$${H}_{pre} ( z ) = \frac{1 - b {z}^{- p}}{1 + a {z}^{- p}} \\ {H}_{post} ( z ) = \frac{1 + a {z}^{- p}}{1 - b {z}^{- p}} \qquad Equation 1$$

Here, a and b represent a multiplier used when implementing each comb filter.

In the exemplary embodiment, the pre-filter and post filter have been implemented as a pole-zero comb filter, but the exemplary embodiments are not limited thereto.

Likewise, in the encoding apparatus, a periodic component included in an audio signal, for example, a harmonic component such as pitch, may be removed using the pre-filter, and the removed periodic component may be represented as a separate parameter so as to generate a modified audio signal. In the encoding apparatus, an overall encoding process for the modified audio signal may be performed. Furthermore, the decoding apparatus may perform an overall decoding process for a bitstream, and then reconstruct the signal to an audio signal before the pre-filtering by using the post filter corresponding to the pre-filter. As a result, even if a window type having a short overlapping section is used, the frequency resolution may be improved, and thus deterioration in the perceptual quality of the reconstructed audio signal may be prevented.

FIG. 4 is a diagram illustrating an example of a window having an overlapping section less than 50% which is applied in the exemplary embodiments.

Referring to FIG. 4, the window type may be composed of first and second zero sections (a1, a2), first and second edge sections (W₁, W₂), and first and second unit sections (b1, b2) having a window coefficient of 1. When two same window types are applied, the second edge section (W₂) of the window type 410 may overlap with the first edge section (W₁) of the window type 430. At this time, the first and second edge sections (W₁, W₂) may be indicated as in Equation 3 from the window function (W(n)) of Equation 2.

$$\begin{matrix} W ( n ) = sin ( \frac{π}{2} \times {sin}^{2} ( \frac{π}{2} \times \frac{n + 0.5}{L} ) ) & Equation 2 \\ {W}_{1} ( n ) = sin ( \frac{π}{2} \times {sin}^{2} ( \frac{π}{2} \times \frac{n + L + 0.5}{L} ) ) , n = 0 , … , L - 1 \\ {W}_{2} ( n ) = sin ( \frac{π}{2} \times {sin}^{2} ( \frac{π}{2} \times \frac{n + 0.5}{L} ) ) , n = 0 , … , L - 1 & Equation 3\end{matrix}$$

Here, n, the number of samples has a value of 0, . . . , 2L−1, and L is a length of an overlapping section and represents, for example, 128 samples.

The window function (W(n)) is a sine wave, and thus the first and second edge sections (W₁, W₂) may guarantee perfect reconstruction in the overlapping section when the condition of Equation 4 below is satisfied.

W₁²(n)+W₂²(n)=1 Equation 4

Furthermore, in order to satisfy conditions of Equation 4 above, the first and second zero sections (a1, a2) and the first and second unit sections (b1, b2) of the window type may be expressed as shown in Equation 5 below.

(F−L)/2 Equation 5

Here, F represents the frame size of the window type, and L represents the length of the overlapping section.

Here, when the frame size of the window is 1024 samples, the length of the overlapping section is 128 samples, and thus the first and second zero sections (a1, a2) and the first and second unit sections (b1, b2) may be 448 samples.

FIGS. 5A to 5C are diagrams illustrating a time delay which is generated by the encoding and decoding process when using the window type illustrated in FIG. 4.

FIG. 5A represents an audio signal which is input to the encoding apparatus, FIG. 5B represents a time-frequency transform which is performed by the encoding apparatus, and FIG. 5C represents a time-frequency inverse-transform which is performed by the decoding apparatus.

In a general AAC codec, a look-ahead sample is needed to determine a window type 530 which the encoding apparatus is to apply to the current frame 510, but according to the exemplary embodiment, a look-ahead sample for determining the window type 530 to be applied to the current frame 510 is not needed by setting the lengths of the overlapping sections between different window types to be the same. As a result, a time delay by the look-ahead sample is not generated at the time of time-frequency transform in the encoding apparatus of FIG. 5A.

Furthermore, in the decoding apparatus, the next frame which overlaps with the current frame needs to be waited for time-frequency inverse-transform. In the general AAC codec, the length of the overlapping section is 1024 samples, and thus a time delay of the amount of 1024 samples may occur. According to an exemplary embodiment, when the length of the overlapping section between different window types is 128 samples, the time delay of the amount of 128 samples may occur.

Furthermore, when the current frame 510 is the first frame of the audio signal, the decoding apparatus needs the time delay of 1024 samples for processing the current frame 510 as in the existing AAC codec.

Consequently, according to an exemplary embodiment, the time delay D by the encoding and decoding process includes a delay by the overlapping section and a delay by the current frame 510, and when the sampling rate is 48 kHz, the total time delay is 24 ms. In contrast, the time delay by the encoding and decoding process of the existing AAC codec includes a delay by the look-ahead sample, a delay by the overlapping section, and a delay by the current frame 510, and when the sampling rate is 48 kHz, the total time delay is 54.7 ms.

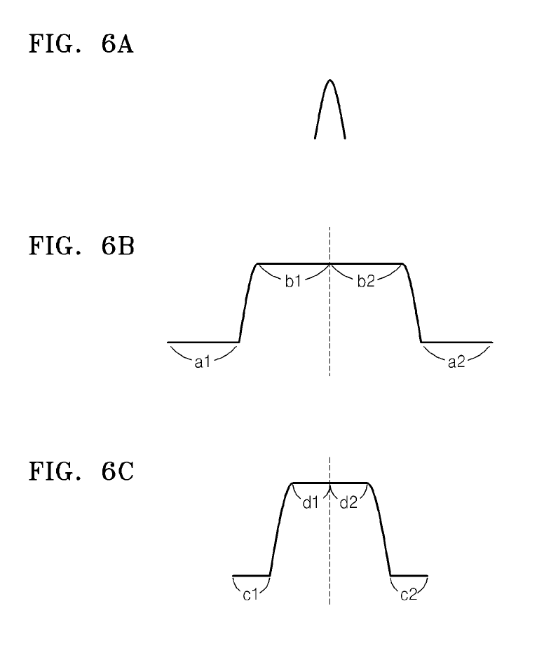

FIGS. 6A to 6C are diagrams illustrating an example of various window types which are applied in the exemplary embodiments. FIG. 6A shows a short window (hereinafter, referred to as “first window type”), FIG. 6B shows a long window (hereinafter, referred to as “second window type”), and FIG. 6C shows a medium window (hereinafter, referred to as “third window type”). Here, the second window type may correspond to the window type illustrated in FIG. 4. According to an exemplary embodiment, the lengths of the first window type and the second window type may be set to be the same as the lengths of the short window and the long window which are used in the AAC codec. In detail, in the case of the AAC codec, for example, if the length of one frame is 1024 samples, the length of the short window is 256 samples, and the length of the long window may be 2048 samples, but the length may be variously changed within the range which is obvious to those of ordinary skill in the art. Furthermore, the third window type may be designed to have various lengths according to characteristics of an audio signal within a range of lengths which are longer than the first window type and shorter than the second window type.

Referring to FIG. 6A, the first window type may be configured without a zero section having the window coefficient of 0 and a unit section having the window coefficient of 1. Furthermore, referring to FIG. 6B, the second window type may have an overlapping section less than 50%. In detail, the second window type may include first and second zero sections (a1, a2) having the window coefficient of 0 and first and second unit sections (b1, b2) having the window coefficient of 1 as in FIG. 4. Furthermore, referring to FIG. 6C, the third window type may have an overlapping section less than 50% as in the second window type. In detail, the third window type may include first and second zero sections (c1, c2), and first and second unit sections (d1, d2).

According to an exemplary embodiment, the third window type may be designed to satisfy Equation 5 above within the range of lengths which are longer than the first window type and shorter than the second window type.

Table 1 below shows lengths of the first and second zero sections and the first and second unit sections according to six different frame sizes of the third window type when the frame size of the first window type is 128 samples and the frame size of the second window type is 1024 samples.

TABLE 1

| | First and second zero sections & first and |
|---|---|
| Window frame size (F) | second unit sections (R) |
| 1024 (128 × 8) | 448 |
| 896 (128 × 7) | 384 |
| 768 (128 × 6) | 320 |
| 640 (128 × 5) | 256 |
| 512 (128 × 4) | 192 |
| 384 (128 × 3) | 128 |
| 256 (128 × 2) | 64 |
| 128 (128 × 1) | 0 |

According to an exemplary embodiment, all of the length of the frame, the length of the first window type, the length of the second window type, and the length of the third window type may be set to 2^{k}. As a result, the amount of calculation, which is needed in the encoding and decoding, may be reduced.

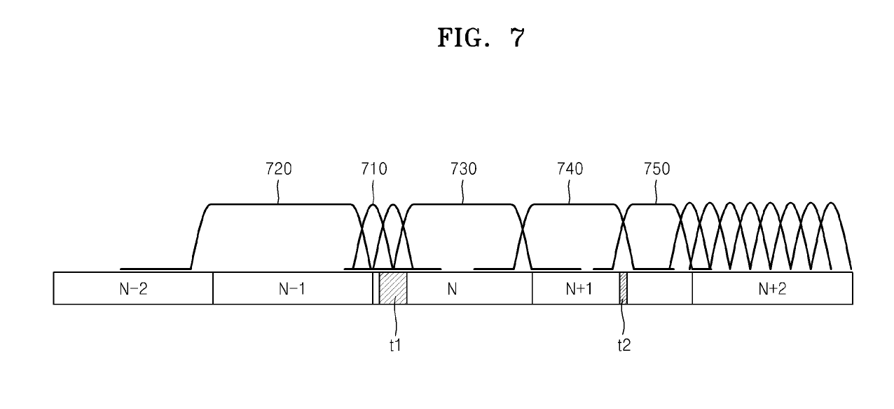

FIG. 7 is a diagram illustrating an example where respective window types 710, 720, 730, 740, and 750 illustrated in FIG. 6 are applied to respective frames. The second window type 720 is applied to frame N−1, the first window type 710 and the third window type are applied to frame N, two third window types 740 and 750 are applied to frame N+1, and eight first window types 710 are applied to frame N+2.

According to an exemplary embodiment, a transition window such as a long start window and a long stop window which connect the first window 710 and the second window 720 is not needed by setting the lengths of the overlapping section between windows to be the same except the section where the window coefficient is 0. As a result, the time delay according to the window switching may be reduced. In detail, the lengths of the overlapping section between the first window type 710, the second window type 720, and the third window types 730, 740, and 750, may be set to be ½ of the length of the first window type 710. When the length of the first window type 710 is 256 samples as in the ACC codec, the length of the overlapping section between the first window type 710, the second window type 720, and the third window types 730, 740, and 750, may become 128 samples. Likewise, the length of the overlapping section between windows gets very small compared to the AAC codec, and thus the time delay by the overlapping process may be reduced.

Furthermore, according to an exemplary embodiment, in the case of a frame where there is a transient, 8 first window types may be applied to the entire frame as in frame N+2. According to another exemplary embodiment, the first window type 710 may be applied to the transient section t1 as in frame N, and the third window type 730 whose length is adjusted may be applied to the remaining section, the third window type 730 being overlapped with the first window type 710.

Further, according to an exemplary embodiment, in the case of a frame having a section t2 where the characteristics of the signal change, the first window type and the third window type may be applied as in the frame having a transient section t1, or two third window types 740 and 750 may be applied. Here, the characteristics of the signal may include the frequency, tone, intensity, etc. of the audio signal. If the section t2 where the characteristics of the signal change is very short, two third window types may be set to overlap to enhance the encoding efficiency. If the length of one third window type is determined, the length of the other third window type may be determined such that the sum of the frame sizes of the third window types 740 and 750 becomes the same as the frame size of the second window type 720. The third window type may also be determined to satisfy the perfect reconstruction condition of the time-frequency transform as in the second window type.

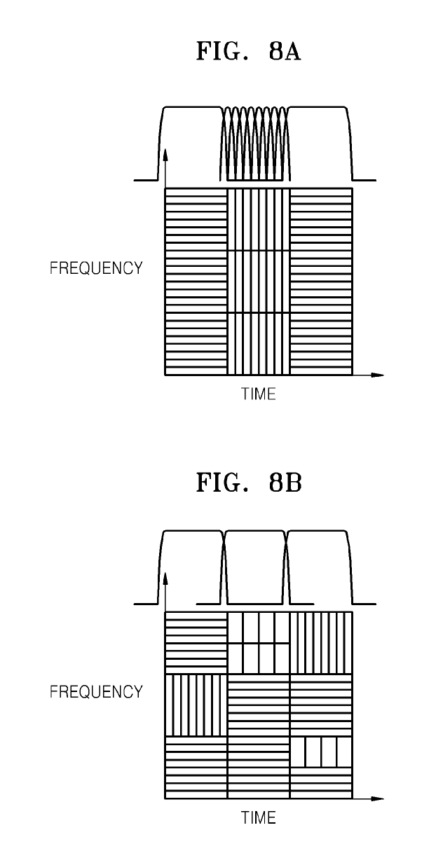

FIGS. 8A and 8B are diagrams illustrating a concept of improving resolution which is applied in the exemplary embodiments. FIG. 8A shows an example where a block size has been applied to the existing entire band, and FIG. 8B shows an example where the block size is applied in sub-band units according to an exemplary embodiment.

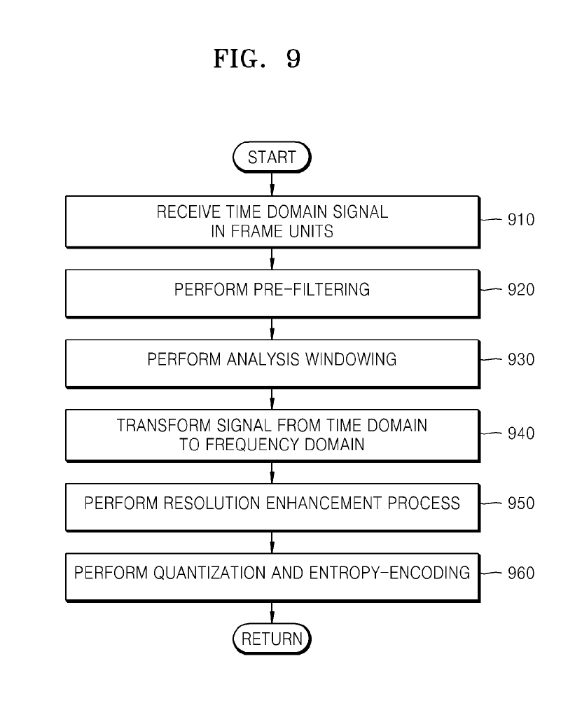

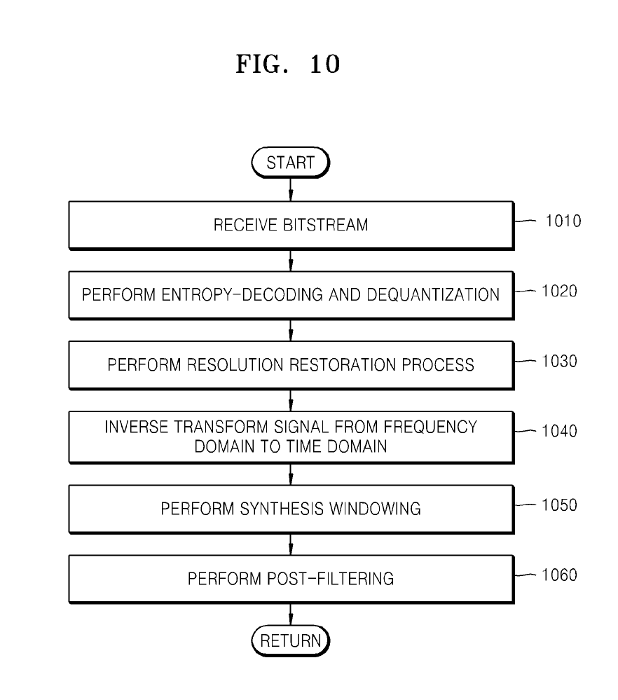

FIG. 9 is a flowchart illustrating an operation of an audio encoding method according to an exemplary embodiment.

Referring to FIG. 9, in operation 910, a signal in the time domain may be received in frame units.

In operation 920, pre-filtering may be performed for the received signal in the time domain. To this end, a periodic component such as a harmonic component, which includes important or perceptual information for the audio signal, may be extracted and the extracted periodic component may be removed by using the pre-filter. The filter coefficients of the pre-filter may be determined by the location and amplitude of the extracted periodic component. The filter coefficients of the pre-filter may be determined in advance through experiment or simulation and may be applied to each frame.

In operation 930, the analysis windowing may be performed for the modified signal in the time domain by the pre-filtering process. One or two window types of FIGS. 6A to 6C may be applied to each frame for the analysis windowing.

In operation 940, the transform coefficients in the frequency domain may be generated by transforming the signal in the time domain where the analysis windowing process has been performed.

In operation 950, the time-frequency resolution enhancement process for the transform coefficients in the frequency domain may be performed. At this time, the time resolution or the frequency resolution may be improved according to the characteristics of the signal by applying a block size which is adaptive to the characteristics of the signal, or the frequency resolution may be improved by merging frequency bins toward a low-frequency band in sub-band units.

In operation 960, the transform coefficients in the frequency domain, where the resolution enhancement process has been performed, may be quantized and entropy-encoded, and may be multiplexed along with the parameters needed for the decoding process so as to generate a bitstream.

Here, operations 920 and 950 may be entirely or selectively performed.

FIG. 10 is a flowchart illustrating an operation of an audio decoding apparatus according to an exemplary embodiment.

Referring to FIG. 10, in operation 1010, the bitstream may be received and demultiplexed, and encoded transform coefficients in the frequency domain and the parameter needed for the decoding process may be extracted.

In operation 1020, the entropy-decoding and dequantization may be performed for the transform coefficients in the frequency domain which are provided in operation 1010. At this time, when different block sizes are allocated in sub-band units, the entropy decoding and dequantization may be performed according to the corresponding block size.

In operation 1030, the resolution of the dequantized transform coefficients in the frequency domain may be restored to the state before the resolution enhancement process by using an inverse matrix of a matrix used during the resolution enhancement process in the encoding apparatus.

In operation 1040, the signal in the time domain may be generated by inverse-transforming the transform coefficients in the frequency domain whose resolution has been restored.

In operation 1050, the synthesis windowing may be performed for the signal in the time domain. At this time, the same window as that used in the analysis windowing in the encoding apparatus may be applied to each frame. The synthesis windowing process may include an overlap-and-add process.

In operation 1060, the post-filtering may be performed for the signal in the time domain where the synthesis windowing has been performed in order to reconstruct the signal into the state before the pre-filtering in the encoding apparatus.

Operations 1030 and 1060 may be entirely or selectively performed according to whether the corresponding process in the encoding apparatus is performed.

The above-described exemplary embodiments may be applied to a core coder which employs the moving picture expert group advanced audio coding (MPEG AAC), MPEG AAC-LD (low delay), or MPEG AAC-ELD (enhanced low delay) algorithm, but may be applied to all codecs which employ the transform encoding.

According to the exemplary embodiments, the time-frequency transform/inverse-transform (e.g., MDCT/IMDCT) may be effectively applied in the encoding and decoding process of audio signals.

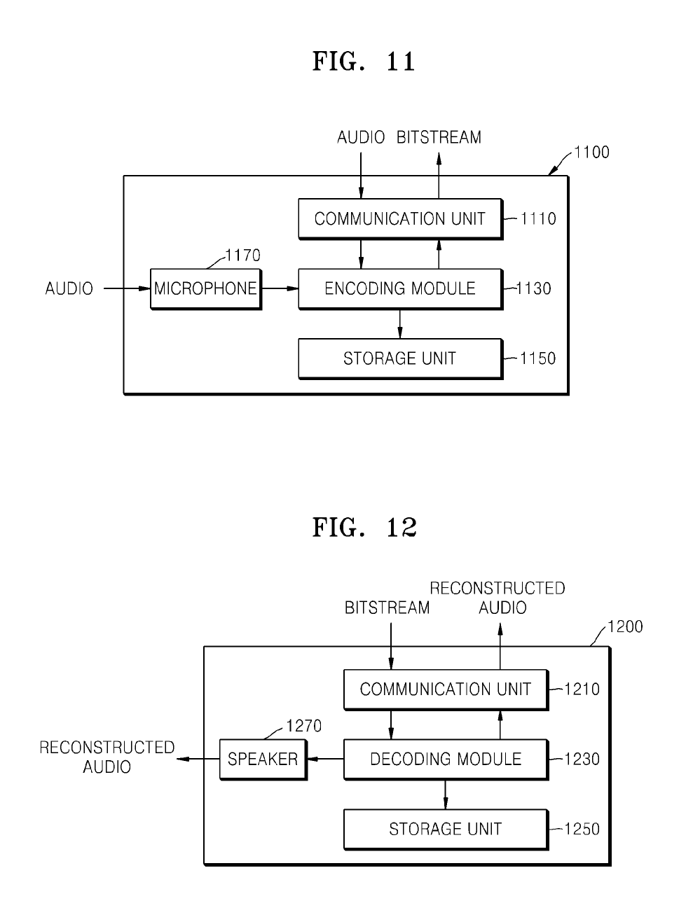

FIG. 11 is a block diagram illustrating a multimedia device including an encoding module according to an exemplary embodiment.

Referring to FIG. 11, the multimedia device 1100 may include a communication unit 1110 and the encoding module 1130. In addition, the multimedia device 1100 may further include a storage unit 1150 for storing an audio bitstream obtained as a result of encoding according to the usage of the audio bitstream. Moreover, the multimedia device 1100 may further include a microphone 1170. That is, the storage unit 1150 and the microphone 1170 may be optionally included. The multimedia device 1100 may further include an arbitrary decoding module (not shown), e.g., a decoding module for performing a general decoding function or a decoding module according to an exemplary embodiment. The encoding module 1130 may be implemented by at least one processor (not shown) by being integrated with other components (not shown) included in the multimedia device 1100 as one body.

The communication unit 1110 may receive at least one of an audio signal or an encoded bitstream provided from the outside or transmit at least one of a restored audio signal or an encoded bitstream obtained as a result of encoding by the encoding module 1130.

The communication unit 1110 is configured to transmit and receive data to and from an external multimedia device through a wireless network, such as wireless Internet, wireless intranet, a wireless telephone network, a wireless Local Area Network (LAN), Wi-Fi, Wi-Fi Direct (WFD), third generation (3G), fourth generation (4G), Bluetooth, Infrared Data Association (IrDA), Radio Frequency Identification (RFID), Ultra WideBand (UWB), Zigbee, or Near Field Communication (NFC), or a wired network, such as a wired telephone network or wired Internet.

According to an exemplary embodiment, the encoding module 1130 may generate the modified signal in a time domain to compensate the frequency resolution in frame units for the signal in the time domain which is provided through the communication unit 1110 or the microphone 1170, analysis-window the modified signal in the time domain by using the window which is designed to have the overlapping section less than 50%, and transform the analysis-windowed signal in the time domain into a signal in a frequency domain. Furthermore, in order to improve the frequency resolution, the frequency bins may be merged toward a low-frequency band in sub-band units for the signal in the frequency domain. Furthermore, in order to enhance the time-frequency resolution, different block sizes may be applied in sub-band units according to the characteristics of the signal in the frequency domain. The modified signal in the time domain may be represented and generated as a separate parameter by removing the periodic elements in frame units. Furthermore, when performing the analysis windowing, at least two window types, which are designed to have the same overlapping section to enable the perfect reconstruction in the overlapping section having different lengths, may be applied.

The storage unit 1150 may store various programs required to operate the multimedia device 1100.

The microphone 1170 may provide an audio signal from a user or the outside to the encoding module 930.

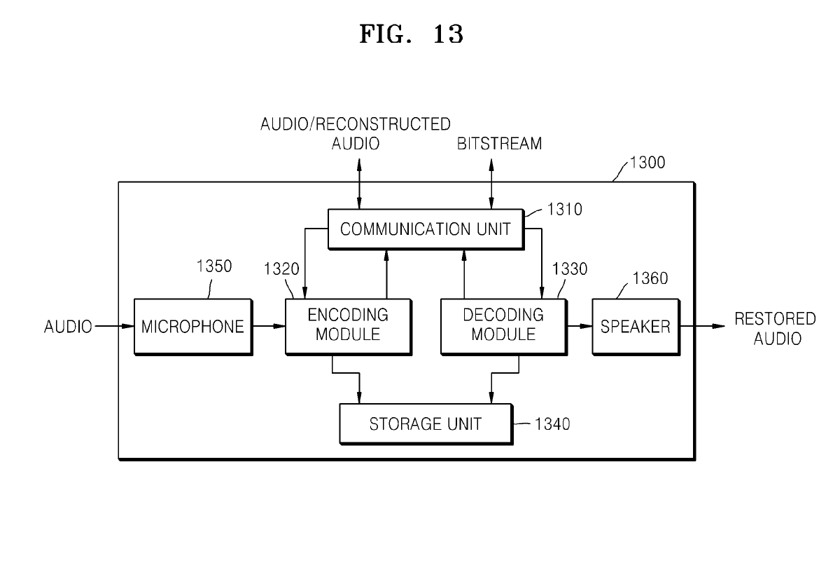

FIG. 12 is a block diagram illustrating a multimedia device including a decoding module, according to an exemplary embodiment.

The multimedia device 1200 of FIG. 12 may include a communication unit 1210 and the decoding module 1230. In addition, according to the use of a reconstructed audio signal obtained as a decoding result, the multimedia device 1200 of FIG. 12 may further include a storage unit 1250 for storing the reconstructed audio signal. In addition, the multimedia device 1200 of FIG. 12 may further include a speaker 1270. That is, the storage unit 1250 and the speaker 1270 are optional. The multimedia device 1200 of FIG. 12 may further include an encoding module (not shown), e.g., an encoding module for performing a general encoding function or an encoding module according to an exemplary embodiment. The decoding module 1230 may be integrated with other components (not shown) included in the multimedia device 1200 and implemented by at least one processor.

Referring to FIG. 12, the communication unit 1210 may receive at least one of an audio signal or an encoded bitstream provided from the outside or may transmit at least one of a reconstructed audio signal obtained as a result of decoding of the decoding module 1230 or an audio bitstream obtained as a result of encoding. The communication unit 1210 may be implemented substantially and similarly to the communication unit 1110 of FIG. 11.

According to an exemplary embodiment, the decoding module 1230 may receive a bitstream which is provided through the communication unit 1210, restore the frequency resolution of the signal in the frequency domain, which is decoded from the bitstream, by demerging frequency bins in sub-band units, inverse-transform the resolution-restored signal in the frequency domain into the signal in the time domain, and perform synthesis-windowing the signal in the time domain by using the window which is designed to have an overlapping section less than 50%. Furthermore, the synthesis-windowed signal in the time domain may be reconstructed to the audio signal before resolution compensation by performing the post-filtering corresponding to the pre-filtering performed in the encoding process for the synthesis-windowed signal in the time domain. Furthermore, at least two window types, which are designed to have the same overlapping section so that perfect reconstruction may be possible in the overlapping section while having different lengths, may be applied in performing synthesis windowing.

The storage unit 1250 may store the reconstructed audio signal generated by the decoding module 1230. In addition, the storage unit 1250 may store various programs required to operate the multimedia device 1200.

The speaker 1270 may output the reconstructed audio signal generated by the decoding module 1230 to the outside.

FIG. 13 is a block diagram illustrating a multimedia device including an encoding module and a decoding module according to an exemplary embodiment.

The multimedia device 1300 shown in FIG. 13 may include a communication unit 1310, an encoding module 1320, and a decoding module 1330. In addition, the multimedia device 1300 may further include a storage unit 1340 for storing an audio bitstream obtained as a result of encoding or a reconstructed audio signal obtained as a result of decoding according to the usage of the audio bitstream or the reconstructed audio signal. In addition, the multimedia device 1300 may further include a microphone 1350 and/or a speaker 1360. The encoding module 1320 and the decoding module 1330 may be implemented by at least one processor (not shown) by being integrated with other components (not shown) included in the multimedia device 1300 as one body.

Since the components of the multimedia device 1300 shown in FIG. 13 correspond to the components of the multimedia device 1100 shown in FIG. 11 or the components of the multimedia device 1200 shown in FIG. 12, a detailed description thereof is omitted.

Each of the multimedia devices 1100, 1200, and 1300 shown in FIGS. 11, 12, and 13 may include a voice communication only terminal, such as a telephone or a mobile phone, a broadcasting or music only device, such as a TV or an MP3 player, or a hybrid terminal device of a voice communication only terminal and a broadcasting or music only device but are not limited thereto. In addition, each of the multimedia devices 1100, 1200, and 1300 may be used as a client, a server, or a transducer displaced between a client and a server.

When the multimedia device 1100, 1200, or 1300 is, for example, a mobile phone, although not shown, the multimedia device 1100, 1200, or 1300 may further include a user input unit, such as a keypad, a display unit for displaying information processed by a user interface or the mobile phone, and a processor for controlling the functions of the mobile phone. In addition, the mobile phone may further include a camera unit having an image pickup function and at least one component for performing a function required for the mobile phone.

When the multimedia device 1100, 1200, or 1300 is, for example, a TV, although not shown, the multimedia device 1100, 1200, or 1300 may further include a user input unit, such as a keypad, a display unit for displaying received broadcasting information, and a processor for controlling all functions of the TV. In addition, the TV may further include at least one component for performing a function of the TV.

According to the exemplary embodiments, an unnecessary delay would not occur when performing a time-frequency transform process/inverse-transform process. According to the exemplary embodiments, the restored sound quality may be improved while reducing a process delay by using a reduced overlapping section when performing the time-frequency transform process/inverse-transform process. According to the exemplary embodiments, the time delay of the high-performance audio codec may be reduced, and thus the time-frequency transform process/inverse-transform process may be used in a two-way communication. According to the exemplary embodiments, the time-frequency transform process/inverse-transform process may be used without an additional time delay in the high sound quality audio codec. According to the exemplary embodiments, the time delay related with the time-frequency transform process/inverse-transform may be reduced without correction or modification of any component in the existing audio codec.

The methods according to the exemplary embodiments can be written as computer-executable programs and can be implemented in general-use digital computers that execute the programs by using a non-transitory computer-readable recording medium. In addition, data structures, program instructions, or data files, which can be used in the embodiments, can be recorded on a non-transitory computer-readable recording medium in various ways. The non-transitory computer-readable recording medium is any data storage device that can store data which can be thereafter read by a computer system. Examples of the non-transitory computer-readable recording medium include magnetic storage media, such as hard disks, floppy disks, and magnetic tapes, optical recording media, such as CD-ROMs and DVDs, magneto-optical media, such as optical disks, and hardware devices, such as ROM, RAM, and flash memory, specially configured to store and execute program instructions. In addition, the non-transitory computer-readable recording medium may be a transmission medium for transmitting signal designating program instructions, data structures, or the like. Examples of the program instructions may include not only mechanical language codes created by a compiler but also high-level language codes executable by a computer using an interpreter or the like.

While exemplary embodiments have been particularly shown and described above, it will be understood by those of ordinary skill in the art that various changes in form and details may be made therein without departing from the spirit and scope of the inventive concept as defined by the appended claims. The exemplary embodiments should be considered in descriptive sense only and not for purposes of limitation. Therefore, the scope of the inventive concept is defined not by the detailed description of the exemplary embodiments but by the appended claims, and all differences within the scope will be construed as being included in the present inventive concept.

What is claimed is:

1. A method of encoding an audio signal, the method comprising:
generating a modified signal in a time domain to compensate a frequency resolution in frame units;
analysis-windowing the modified signal in the time domain by using a window which is designed to have an overlapping section less than 50%; and
generating transform coefficients in a frequency domain by transforming the analysis-windowed signal in the time domain.

2. The method of claim 1, further comprising:
merging frequency bins toward a low-frequency band in sub-band units for transform coefficients in the frequency domain in order to improve the frequency resolution.

3. The method of claim 1, further comprising:
applying different block sizes in sub-band units according to characteristics of the transform coefficients in the frequency domain in order to improve the frequency resolution.

4. The method of claim 1, wherein the generating of the modified signal in the time domain comprises removing a periodic component in frame units and representing the removed periodic component as a separate parameter.

5. The method of claim 1, wherein the analysis-windowing comprises applying at least two window types which are designed to have a same overlapping section except a section where a window coefficient is 0 so that perfect reconstruction is possible in the overlapping section, while having different lengths.

6. A method of encoding an audio signal, the method comprising:
analysis-windowing a signal in a time domain in frame units by using at least two window types which are designed to have a same overlapping section, while having different lengths;
transforming the analysis-windowed signal in the time domain into a signal in a frequency domain; and
merging frequency bins toward a low-frequency band in sub-band units for the signal in the frequency domain to improve a frequency resolution.

7. The method of claim 6, further comprising:
applying different block sizes in sub-band units according to characteristics of the signal in the frequency domain to improve a time-frequency resolution.

8. The method of claim 7, further comprising:
generating a modified signal in a time domain by removing a periodic component in frame units, and providing the modified signal in the time domain instead of the signal in the time domain for the analysis-windowing.

9. A method of decoding an audio signal, the method comprising:
restoring a frequency resolution by demerging frequency bins in sub-band units for a signal in a frequency domain which is decoded from a bitstream;
inverse-transforming the resolution-restored signal in the frequency domain into a signal in a time domain; and
synthesis-windowing the signal in the time domain by using a window type which is designed to have an overlapping section less than 50%.

10. The method of claim 9, further comprising:
reconstructing an audio signal before resolution compensation by performing post-filtering on the synthesis-windowed signal in the time domain, corresponding to pre-filtering which is performed in an encoding process.

11. The method of claim 9, the synthesis-windowing comprises:
applying at least two window types which are designed to have a same overlapping section except a section where a window coefficient is 0 so that perfect reconstruction is possible in the overlapping section, while having different lengths.

12. An apparatus for decoding an audio signal, the apparatus comprising:
a pre-filtering unit configured to generate a modified signal in a time domain to compensate a frequency resolution in frame units;
an analysis-windowing unit configured to perform analysis-windowing on the modified signal in the time domain by using a window type which is designed to have an overlapping section less than 50%;
a transform unit configured to transform an analysis-windowed signal in the time domain into a signal in a frequency domain; and
a resolution enhancement unit configured to merge frequency bins toward a low-frequency band in sub-band units for the signal in the frequency domain to improve the frequency resolution.

13. The apparatus of claim 12, wherein the resolution enhancement unit is configured to apply different block sizes in sub-band units according to characteristics of the signal in the frequency domain to improve the time-frequency resolution.

14. The apparatus of claim 12, wherein the analysis-windowing unit is configured to apply at least two window types which are designed to have a same overlapping section except a section where a window coefficient is 0 so that perfect reconstruction is possible in the overlapping section, while having different lengths.

15. An apparatus for decoding an audio signal, the apparatus comprising:
a frequency resolution restoration unit configured to restore a frequency resolution by demerging frequency bins in sub-band units for a signal in a frequency domain which is decoded from a bitstream;
an inverse-transform unit configured to inverse-transform the resolution-restored signal in the frequency domain into a signal in a time domain;
a synthesis-windowing unit configured to perform synthesis-windowing on the signal in the time domain by using a window type which is designed to have an overlapping section less than 50%; and
a post-filtering unit configured to reconstruct an audio signal before resolution compensation by performing post-filtering on the synthesis-windowed signal in the time domain, corresponding to pre-filtering which is performed in an encoding process.

16. The apparatus of claim 15, wherein the synthesis-windowing unit is configured to apply at least two window types which are designed to have a same overlapping section except a section where a window coefficient is 0 so that perfect reconstruction is possible in the overlapping section, while having different lengths.

17. A multimedia device comprising:
a communication unit configured to receive at least one of an audio signal and an encoded bitstream, or transmit at least one of an encoded audio signal and a reconstructed audio signal; and
a decoding module configured to restore a frequency resolution by demerging frequency bins in sub-band units for a signal in a frequency domain which is decoded from a bitstream, inverse-transform the resolution-restored signal in the frequency domain into a signal in a time domain, and perform synthesis-windowing on the signal in the time domain by using a window type which is designed to have an overlapping section less than 50%.

18. The multimedia device of claim 17, further comprising:
an encoding module configured to generate a modified signal in a time domain to compensate a frequency resolution in frame units, perform analysis-windowing on the modified signal in the time domain by using a window type which is designed to have an overlapping section less than 50%, and transform the analysis-windowed signal in the time domain into a signal in a frequency domain.

19. The multimedia device of claim 18, wherein the analysis-windowing and the synthesis windowing are performed by applying at least two window types which are designed to have a same overlapping section except a section where a window coefficient is 0 so that perfect reconstruction is possible in the overlapping section, while having different lengths.

20. A recording medium readable by a computer which may execute a method of claim 1.
